(19) United States
(12) Patent Application Publication
(10) Pub. No.: US 2017/0117071 A1
(43) Pub. Date: Apr. 27, 2017

(54) WIRE HARNESS

(71) Applicant: SUMITOMO WIRING SYSTEMS, LTD., Mie (JP)

(72) Inventors: Masataka WAKABAYASHI, Mie (JP); Shota ARAGIRI, Mie (JP)

(73) Assignee: SUMITOMO WIRING SYSTEMS, LTD., Mie (JP)

(21) Appl. No.: 15/296,320

(22) Filed: Oct. 18, 2016

(30) Foreign Application Priority Data
Oct. 26, 2015 (JP) 2015-209988

(51) Int. Cl. H01B 7/282; H01B 7/02; H01B 3/44; H01R 13/52; H01B 7/00

(52) U.S. Cl. CPC H01B 7/2825; H01R 13/5221; H01B 7/0045; H01B 3/441; H01B 7/0216

(57) ABSTRACT

A wire harness includes a group of wires having a plurality of covered electrical wires; a terminal provided to each lead wire end portion; a connector having a plurality of cavities which house and hold each terminal; a connector cover that is a resin mold body having a small opening tubular portion, a trumpet-shaped tubular portion, and a large opening tubular portion covering the connector; and a sheet fixating portion having a belt-like sheet wound over an area from the small opening tubular portion of the connector cover to a predetermined length of the covered electrical wires in a spiral form. The sheet fixating portion has a two-layer structure having a belt-like polyolefin sheet and a foaming agent layer, and is heated in a wound state with the foaming agent layer facing inward, the foaming agent layer foaming so as to fill gaps between the connector cover.

### CROSS-REFERENCE TO RELATED APPLICATIONS

The present application claims priority under 35 U.S.C. §119 of Japanese Application No. JP2015-209988, filed on Oct. 26, 2015, the disclosure of which is expressly incorporated by reference herein in its entirety.

### BACKGROUND OF THE INVENTION

1. Field of the Invention

The present invention relates to a waterproofed wire harness used to connect electrical wires in automobiles and the like.

2. Description of Related Art

In wire harnesses that are installed in automobiles and the like, a protective structure has been proposed such as a waterproofing structure to prevent water from entering from outside into a gap between an electrical wire and a connector connected to an end portion thereof. In Japanese Patent Laid-Open Publication No. 2013-187004, for example, a configuration is disclosed in which the gap between the electrical wire and the connector is covered by an adhesive tape.

A connector-provided electrical wire 1 disclosed in Japanese Patent Laid-Open Publication No. 2013-187004 includes an insulated electrical wire 9, a connector 8 connected to an end portion of the insulated electrical wire 9, and a covered member 7 covering a gap between the connector 8 and the insulated electrical wire 9. The covered member 7 is a member in which an ultraviolet curable adhesive tape, having a two-layer structure having a base body made of a tape-like ultraviolet curable resin and an adhesive agent, wound over a portion from the connector 8 to the insulated electrical wire 9 with the adhesive agent facing inward, and then cured. Thereby, water is prevented from entering from the gap between the electrical wire and the connector.

However, when there are many electrical wires and the connector is large in size, an incline is formed on a connection portion of the insulated electrical wires and the connector, thus making it difficult to wind the covered member 7 without gaps.

Thus, traditionally, a connector cover as illustrated in FIG. 6 is used to reduce the inclination of the connection portion of the group of electrical wires and the connector. The connector cover illustrated in FIG. 6 has a substantially trapezoidal column-like shape that increases in a width direction toward an insertion direction of the electrical wires. In a state where the group of wires having terminals crimped thereto is passed through the connector cover, the terminals are inserted into the connector, thereby engaging the connector cover with the connector. Then, after the connector and the connector cover are engaged, PVC tape or the like is wound over the connector cover and the group of wires.

Since a diameter on an inlet side of the connector cover is not so different from a diameter of the entire group of electrical wires, the inclination of the connection portion of the inlet of the connector cover and the group of electrical wires is reduced. Thereby, the PVC tape can be wound over the connection portion without gaps.

However, depending upon the adhesive tape (such as the PVC tape), it is difficult to completely eliminate gaps between the connector cover and the PVC tape, and entry of water from outside the wire harness cannot be prevented completely.

### SUMMARY OF THE INVENTION

The present invention provides a wire harness in which water from outside the wire harness is prevented from entering an interior of the wire harness, thereby enabling enhancement of waterblocking performance.

In order to achieve the objective noted above, a wire harness according to an embodiment of the present invention includes a group of wires having a plurality of covered electrical wires in which an end portion of an insulation sheath is stripped off to expose a lead wire end portion; a terminal provided to each lead wire end portion; a connector having a plurality of cavities which house and hold each terminal in a state where an end portion of the covered electrical wires is spread in a fan shape; a connector cover that is a resin mold body having a small opening tubular portion, a trumpet-shaped tubular portion, and a large opening tubular portion, and configured so that a base end portion of the group of wires on a side not spread in the fan-shape is passed through the small opening tubular portion and the large opening tubular portion covers the connector; and a sheet fixating portion having a belt-like sheet wound, in a spiral form, over an area from the small opening tubular portion of the connector cover to a predetermined length of the covered electrical wires. The sheet fixating portion has a two-layer structure having a belt-like polyolefin sheet and a foaming agent layer, the foaming agent layer being provided on one side of the polyolefin sheet having an adhesive and heat foamable foaming agent coated and laminated thereon. The sheet fixating portion is heated in a wound state with the foaming agent layer facing inward, and the foaming agent layer foams so as to fill gaps between the connector cover.

According to this configuration, since the foaming agent layer of the two-layer structure of the sheet fixating portion that is wound over the connector cover and the group of wires in the spiral form foams so as to fill gaps between the foaming agent layer and the connector cover, the wire harness according to the present embodiment of the present invention can prevent water from outside from entering the interior of the wire harness through gaps between the connector cover and the polyolefin sheet. Thus, the waterblocking performance of the wire harness can be enhanced.

Further, since the foaming agent layer similarly fills gaps between the covered electrical wires and the polyolefin sheet, water can be prevented from entering through gaps between the covered electrical wires and the polyolefin sheet as well, thereby enhancing waterblocking performance.

In addition, the polyolefin sheet before heating has a preferable thickness of about 0.3-1.5 mm, and more preferably a thickness of about 0.5-1.0 mm.

According to this configuration, it is easy to perform a winding operation, and in an foaming operation after winding, the polyolefin sheet foams to a preferable thickness after heating and seals the gaps, thereby enabling effective waterblocking.

According to the present invention, water from outside the wire harness is prevented from entering the interior of the wire harness, thereby enabling enhancement of waterblocking performance.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a longitudinal section view of a wire harness according to an embodiment of the present invention;

FIGS. 2A and 2B are a top view and a lateral view, respectively, of a sheet member according to the embodiment of the present invention;

FIG. 3 is a perspective view of a state where the sheet member is beginning to be wound over the wire harness according to the embodiment of the present invention;

FIG. 4 is a perspective view of a state where the sheet member has been wound over the wire harness according to the embodiment of the present invention;

FIG. 5 is a perspective view of a state where the sheet member wound over the wire harness is heated according to the embodiment of the present invention; and

FIG. 6 is a perspective view of a wire harness with conventional tape winding.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the forms of the present invention may be embodied in practice.

In the following, an embodiment of the present invention is described with reference to the drawings.

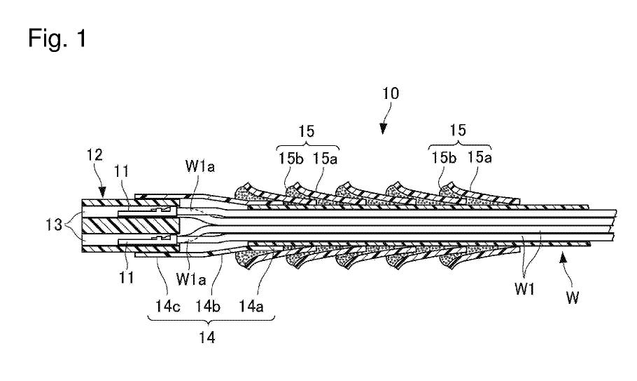

FIG. 1 is a longitudinal section view of a wire harness according to a first embodiment of the present invention. As illustrated in FIG. 1, a wire harness 10 includes a group of wires W, terminals 11, a connector 12, a connector cover 14, and a sheet fixating portion 15.

The group of wires W has a plurality of covered electrical wires W1. On each covered electrical wire W1, an end portion of an insulation sheath 16 (made of PVC or the like) is stripped off to expose a lead wire end portion W1a. The terminals 11 are crimped to the lead wire end portions W1a. The end portion of the insulation sheath 16 is configured such that the end portion (a length of 10-15 mm, for example) of the insulation sheath 16 is stripped off to expose the lead wire. The lead wire can be one copper wire or the like having a large diameter. Further, the lead wire can be an aluminum wire.

The connector 12 has a plurality of cavities 13. The cavities 13 house and hold each terminal 11 in a state where an end portion of the covered electrical wires W1 on a front side in an insertion direction is spread in a fan shape. The connector 12 can be, for example, an injection-molded body made of an LCP (liquid crystal polymer) resin in which anisotropy has been relaxed by combining fillers such as glass fibers (GF) and inorganic fillers and the like therewith and which thus has excellent precision moldability and heat-resistance; or made of polyester resin, polyamide resin, polypropylene resin, polyethylene resin, or the like. Further, the connector 12 can be an injection-molded body made of a reinforced polyethylene terephthalate resin combined with GF and inorganic fillers.

The connector cover 14 is a resin molded body having, in order from a right side of FIG. 1, a small opening tubular portion 14a, a trumpet-shaped tubular portion 14b, and a large opening tubular portion 14c. The connector cover 14 is configured so that a base end portion of the group of wires W on a side not spread in the fan-shape is passed through the small opening tubular portion 14a, and the large opening tubular portion 14c covers the connector 12. The connector cover 14 is formed of synthetic resin such as polyvinyl chloride. The base end portion of the group of wires W on the side not spread in the fan-shape refers to a portion rearward of the above-noted end portion of the covered electrical wires W1 on the front side in the insertion direction that is spread in the fan-shape.

The small opening tubular portion 14a is an opening portion to allow insertion of the group of wires W, and an opening diameter of the opening portion is slightly larger than the diameter of the group of wires W. The trumpet-shaped tubular portion 14b is connected to the small opening tubular portion 14a and is a tube having a trumpet-shape that increases in diameter toward the front side in the insertion direction of the group of wires W. The large opening tubular portion 14c is connected to the trumpet-shaped tubular portion 14b and an opening diameter thereof is larger than the diameter of the small opening tubular portion 14a on the inlet side. In addition, the large opening tubular portion 14c is a size larger than the connector 12 so that it can cover the connector 12.

The sheet fixating portion 15 is configured by winding a belt-like sheet, in a spiral form, over an area from the small opening tubular portion 14a of the connector cover 14 to a predetermined length on the covered electrical wires W 1. The predetermined length as used herein is a length of the group of wires W in the insertion direction when, for example, the belt-like sheet is wound about four to five times so as to wrap in a spiral form.

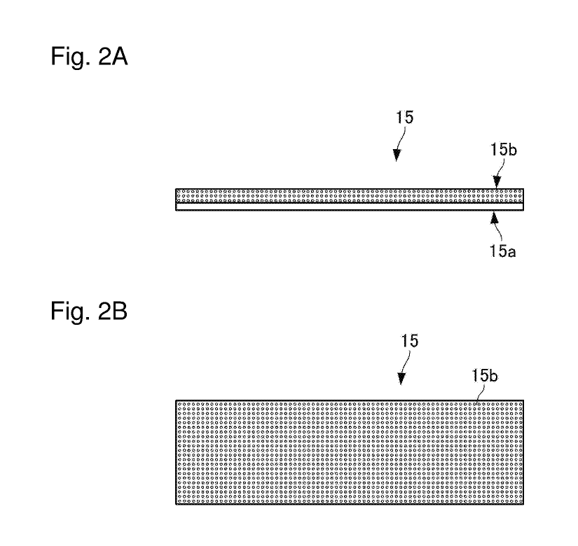

As illustrated in FIG. 2A, the sheet fixating portion 15 has a two-layer structure having a belt-like polyolefin sheet 15a and a foaming agent layer 15b, the foaming agent layer 15 being provided on one side of the polyolefin sheet 15a having an adhesive and heat foamable foaming agent coated and laminated thereon. Whereas FIG. 2B illustrates a reverse surface of the polyolefin sheet 15a, the foaming agent is coated on the entire reverse surface of the polyolefin sheet 15a. Materials used for the polyolefin sheet 15a include PVC, polyamid, polyester, polypropylene, and polyethylene.

A urethane foaming agent is used for the foaming agent, for example, and the foaming agent layer 15b before heating (as described below) has a thickness of about 0.3-1.5 mm, and more preferably a thickness of about 0.5-1.0 mm. A reason for making the polyolefin sheet 15a to be of this thickness is to prevent deterioration of workability of the winding operation by making the polyolefin sheet 15a too thick, and to bring the foaming agent layer 15b to a preferable thickness when it is caused to foam after heating, thereby easily sealing gaps between the polyolefin sheet 15a and the group of wires W.

The urethane foaming agent, when wound over the group of wires W, also serves as a cushion material to reduce impact and the like applied externally to the wire harness 10. Although the urethane foaming agent is used as the foaming agent in the present embodiment, another foaming agent can be used as long as it is adhesive and heat foamable.

The sheet fixating portion 15 is heated in a wound state with the foaming agent layer 15b facing inward, and the foaming agent layer 15b foams so as to fill gaps between the foaming agent layer 15b and the connector cover 14.

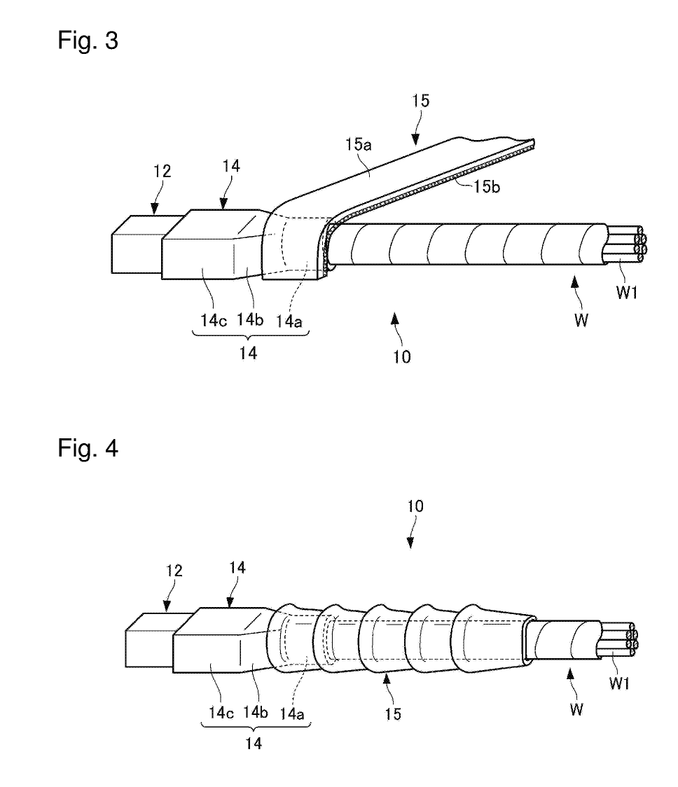

Next, a process of winding and heat foaming the polyolefin sheet 15a is described with reference to FIGS. 3 through 5.

First, as illustrated in FIG. 3, the polyolefin sheet 15a having the urethane foaming agent coated and laminated thereon is wound over the connector cover 14 and the group of wires W in the spiral form, so as to cover the small opening tubular portion 14a that is on an insertion side of the connector cover 14 on which the group of wires W is inserted. The polyolefin sheet 15a is wound so that the foaming agent layer 15b having the urethane foaming agent coated thereon faces inward, and the foaming agent layer 15b is made to adhere directly to the group of wires W.

The polyolefin sheet 15a is wound over the group of wires W in the spiral form up until the predetermined length of the covered electrical wires W1. Since the urethane foaming agent is adhesive, the polyolefin sheet 15a can be wound over the connector cover 14 and the covered electrical wires W1 and adhered in a wound state without using an adhesive agent or the like.

Although in the present embodiment the polyolefin sheet 15a is wound about four to five times, for example, as illustrated in FIG. 4, it may be wound fewer or more times. In addition, in the present embodiment, the polyolefin sheet 15a is wound in a half-wrap where one half of a sheet width overlaps; however, the overlapping portion may be increased so that two thirds of the sheet width overlaps, or the overlapping portion can be decreased.

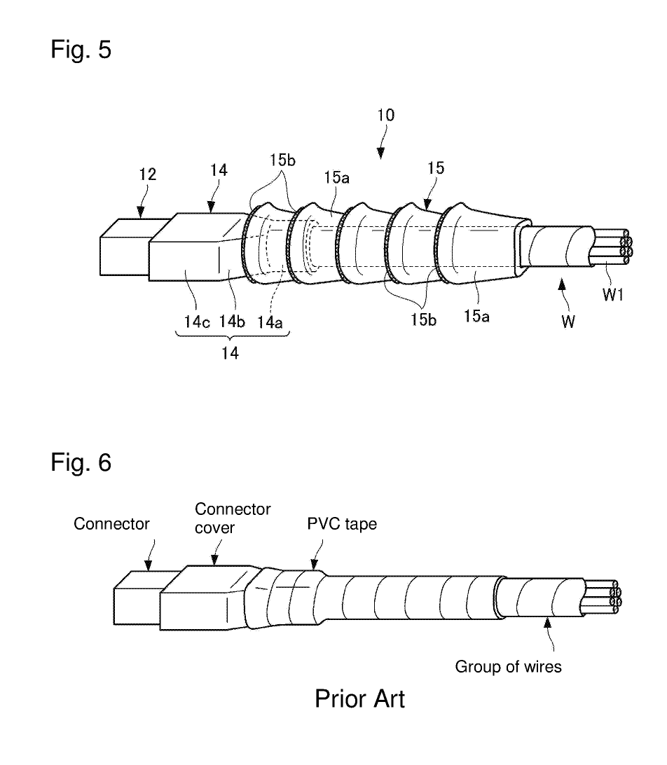

Upon completion of winding the polyolefin sheet 15a to the connector cover 14 and the group of wires W, the polyolefin sheet 15a is heated by a heater, such as a dryer and the like. As illustrated in FIG. 5, by heating the polyolefin sheet 15a, the urethane foaming agent coated on the foaming agent layer 15b is heated and foams. Although the urethane foaming agent in the present embodiment foams when heated to about 80° C., a level of heating is not limited thereto.

Upon foaming by heating, the foaming agent layer 15b expands in volume to about two to three times a volume before foaming. Due to foaming of the foaming agent layer 15b, the foaming agent layer 15b fills gaps between the connector cover 14. Thus, gaps between the polyolefin sheet 15a and the connector cover 14 can be eliminated (see FIG. 1). Accordingly, water outside the wire harness 10, such as water running along the group of wires W, can be prevented from entering gaps between the connector cover 14 and the polyolefin sheet 15a.

As described above, the wire harness 10 according to the present embodiment includes the group of wires W having the plurality of covered electrical wires W1 in which the end portion of the insulation sheath 16 is stripped off to expose the lead wire end portion W1a; the terminal 11 provided to each lead wire end portion W1a; the connector 12 having the plurality of cavities 13 which house and hold each terminal 11 in the state where the end portion of the covered electrical wires W1 is spread in the fan shape; the connector cover 14 that is the resin mold body having the small opening tubular portion 14a, the trumpet-shaped tubular portion 14b, and the large opening tubular portion 14c, and configured so that the base end portion of the group of wires W on the side not spread in the fan-shape is passed through the small opening tubular portion 14a and the large opening tubular portion 14c covers the connector 12; and the sheet fixating portion 15 having the belt-like sheet wound over the area from the small opening tubular portion 14a of the connector cover 14 to the predetermined length of the covered electrical wires W1 in the spiral form.

In addition, the sheet fixating portion 15 of the wire harness 10 has the two-layer structure having the belt-like polyolefin sheet 15a and the foaming agent layer 15b, the foaming agent layer 15b being provided on one side of the polyolefin sheet 15a having the adhesive and heat foamable urethane foaming agent coated and laminated thereon. The sheet fixating portion 15 is heated in the wound state with the foaming agent layer 15b facing inward, and the foaming agent layer 15b foams so as to fill gaps between the connector cover 14.

According to this configuration, since the foaming agent layer 15b of the two-layer structure of the sheet fixating portion 15 that is wound over the connector cover 14 and the group of wires W in the spiral form foams so as to fill gaps between the connector cover 14, the wire harness 10 according to the present embodiment can prevent outside water from entering an interior of the wire harness 10 through gaps between the connector cover 14 and the polyolefin sheet 15a. Thus, a waterblocking performance of the wire harness 10 can be enhanced.

Also, since the foaming agent layer 15b similarly fills gaps between the covered electrical wires W1 and the polyolefin sheet 15a, water can be prevented from entering through gaps between the covered electrical wires W1 and the polyolefin sheet 15a as well, thereby enhancing waterblocking performance.

In addition, the polyolefin sheet 15a before heating has a preferable thickness of about 0.3-1.5 mm, and more preferably a thickness of about 0.5-1.0 mm.

According to this configuration, it is easy to perform the winding operation of the polyolefin sheet 15a, thereby enhancing workability, and the polyolefin sheet 15a foams to a preferable thickness after heating and seals gaps between the polyolefin sheet 15a and the group of wires W, thereby enabling effective waterblocking.

It is noted that a technical scope of the wire harness according to the present invention is not limited to the above-described embodiments, and includes various modifications to each component disclosed within a scope of the claimed invention.

As described above, the wire harness according to the present embodiment of the present invention has an effect of preventing water from outside the wire harness from entering the interior of the wire harness, thereby enabling enhancement of waterblocking performance, and is useful for wire harnesses in general.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. A wire harness, comprising:
a group of wires having a plurality of covered electrical wires in which an end portion of an insulation sheath is stripped off to expose a lead wire end portion;
a terminal provided to each lead wire end portion;
a connector having a plurality of cavities, the cavities housing and holding each terminal in a condition in which an end portion of the covered electrical wires is spread in a fan shape;
a connector cover comprising a resin mold body having a small opening tubular portion, a trumpet-shaped tubular portion, and a large opening tubular portion, the small opening tubular portion configured for insertion of a base end portion of the group of wires on a side not spread in the fan-shape, and the large opening tubular portion covering the connector; and
a sheet fixating portion comprising a sheet wound, in a spiral form, over an area from the small opening tubular portion of the connector cover to a predetermined length of the covered electrical wires,
wherein,
the sheet fixating portion has a two-layer structure having a polyolefin sheet and a foaming agent layer, the foaming agent layer being provided on one side of the polyolefin sheet having an adhesive and heat foamable foaming agent coated and laminated thereon, and
the sheet fixating portion is heated in a wound condition with the foaming agent layer facing inward, the foaming agent layer foaming so as to fill gaps between the connector cover.

2. The wire harness according to claim 1, wherein the polyolefin sheet before heating has a thickness of about 0.3-1.5 mm.

3. The wire harness according to claim 1, wherein the polyolefin sheet before heating has a thickness of about 0.5-1.0 mm.
